(19) United States
(12) Patent Application Publication
(10) Pub. No.: US 2021/0033877 A1
(43) Pub. Date: Feb. 4, 2021

(54) LASER AIMER LED LAMP

(71) Applicant: Jialei Ma, Xingping (CN)

(72) Inventor: Jialei Ma, Xingping (CN)

(21) Appl. No.: 16/556,252

(22) Filed: Aug. 30, 2019

(30) Foreign Application Priority Data
Jul. 31, 2019 (CN) 201921222987.6

(51) Int. Cl. G02B 27/20; F21V 7/04

(52) U.S. Cl. CPC G02B 27/20; F21Y 2115/10; F21V 7/04

(57) ABSTRACT

The invention discloses a laser aimer LED lamp comprising a lamp cup with a laser light set internally and an LED lamp set in the center of the lamp cup. The irradiation direction of the laser light is the same as that of centralized light of LED lamp after reflected by lamp cup. The laser aimer LED lamp is installed on other products, laser light located at any point in the annular area between the LED lamp and the shell. The laser aimer LED lamp includes a shell with a lamp cup, an LED lamp, and a laser light all inside the shell. The lamp cup is in the shape of trumpet, the opening end of which is set with a transparent protecting cover.

### BACKGROUND OF THE INVENTION

### 1. Field of the Invention

The invention relates to the technical field of laser aimer, specifically relating to a laser aimer LED lamp.

### 2. Description of the Related Art

The laser aimer technology is employed in fields of military use and civil use. Traditional laser aimer is large in size and heavy in weight. As a result, it rises the difficulty of operators' aiming, greatly affects the accuracy rate of shooting and make products installed with laser aimer LED lamp appears neither delicate nor beautiful, which furthermore becoming the barrier of industrial rapid development.

### SUMMARY OF THE INVENTION

The invention presents a laser aimer LED lamp to overcome said technical problems.

To solve above technical problems, the invention provides a laser aimer LED lamp which includes a lamp cup, an LED lamp set in the center of the lamp cup. A laser light is set inside the lamp cup.

The improvement of the invention is that the irradiation direction of said laser light is the same as that of centralized light of LED lamp after reflected by lamp cup.

The improvement of the invention is that said laser aimer LED lamp includes a shell with a lamp cup, an LED lamp, and a laser light all inside the shell.

The improvement of the invention is that when said laser aimer LED lamp is installed on other products, said laser light located at any point in the annular area between the LED lamp and the shell.

The improvement of the invention is that the lamp cup is in the shape of trumpet, the opening end of which is set with a transparent protecting cover.

Compared with prior art, the invention has following advantages: The invention is fixed via the misalignment of lamp cup and laser light. Given structural features of lamp cup, the laser light is installed inside the lamp cup to guarantee that the view can be provided for the laser aimer more accurately and swiftly as the light from laser and LED is both irradiated from the lamp cup. LED is used for lighting and laser is used for aiming, which enhances the accuracy of aiming and reduces volume of laser aimer LED lamp remarkably. The invention has simpler structure and lighter weight, thus having great practicability and commercial value.

### BRIEF DESCRIPTION OF THE DRAWINGS

FIG. 1 is the structural diagram of the laser aimer LED lamp of the invention.

As shown: 1. lamp cup, 2. LED lamp, 3. laser light, 4. shell, 5. transparent covering.

### DETAILED DESCRIPTION OF THE PREFERRED EMBODIMENTS

The invention is further described in detail hereinafter with reference to the drawings.

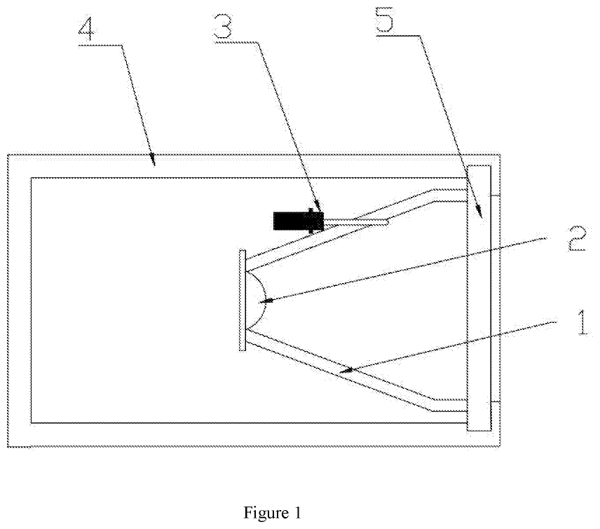

According to FIG. 1, a laser aimer LED lamp includes the lamp cup 1, the LED lamp 2 set in the center of lamp cup 1; the laser light 3 is set inside the lamp cup 1.

The irradiation direction of said laser light is the same as that of centralized light of LED lamp 2 after reflected by lamp cup 1.

Said laser aimer LED lamp is installed on other products, said laser light 3 is right above the LED lamp 2.

Said laser aimer LED lamp includes the shell 4 with the lamp cup 1, the LED lamp 2, and the laser light 3 all inside the shell 4.

Said lamp cup 1 is in the shape of trumpet, the opening end of which is set with a transparent protecting cover 5.

In the specific implementation, the laser aimer LED lamp is installed on other products. When there is a need to aim at the object, it can be achieved through opening the LED lamp 2 and laser light 3.

The invention is fixed via the misalignment of lamp cup and laser light. Given structural features of lamp cup, the laser light is installed inside the lamp cup to guarantee that the view can be provided for the laser aimer more accurately and swiftly as the light from laser and LED is both irradiated from the lamp cup. LED is used for lighting and laser is used for aiming, which enhances the accuracy of aiming and reduces volume of laser aimer LED lamp remarkably. The invention has simpler structure and lighter weight, thus having great practicability and commercial value.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A laser aimer LED lamp, comprising a lamp cup and an LED lamp set in the center of the lamp cup; a laser light is set inside the lamp cup.

2. The laser aimer LED lamp of claim 1, wherein the irradiation direction of the laser light is the same as that of centralized light of LED lamp after reflected by the lamp cup.

3. The laser aimer LED lamp of claim 1, further includes a shell, the lamp cup, the LED lamp and the laser light are all located in the shell.

4. The laser aimer LED lamp of claim 3, wherein when the laser aimer LED lamp is installed on other products, the laser light located at any point in the annular area between the LED lamp and the shell.

5. The laser aimer LED lamp of claim 1, wherein the lamp cup is in the shape of trumpet, the opening end of which is set with a transparent protecting cover.
